(19) United States
(12) Patent Application Publication
(10) Pub. No.: US 2020/0056576 A1
(43) Pub. Date: Feb. 20, 2020

(54) PUMPED-STORAGE HYDROELECTRICITY GENERATOR

(71) Applicant: Oei Sik OH, Daejeon (KR)

(72) Inventor: Oei Sik OH, Daejeon (KR)

(21) Appl. No.: 16/609,189

(22) PCT Filed: May 3, 2018
(86) PCT No.: PCT/KR2018/005161

§ 371 Date: Oct. 28, 2019

(30) Foreign Application Priority Data
May 12, 2017 (KR) 20-2017-0002338

(51) Int. Cl. F03B 9/00; F03B 13/08

(52) U.S. Cl. CPC F03B 9/005; F03B 17/066; F03B 13/08

(57) ABSTRACT

The present invention relates to a pumped-storage hydroelectricity generator and, more particularly, to a pumped-storage hydroelectricity generator with improved efficiency, capable of converting water stored in an upper portion into electric energy as much as possible while minimizing loss of the water. The present invention provides a pumped-storage hydroelectricity generator, which includes: an upper water tank to store pumped water, rainwater, or river water input via a pipe using midnight electricity; a hydraulic turbine that receives the stored water from an outlet of the upper water tank and is rotated to generate rotational force; a generator to produce electricity by the rotational force of the hydraulic turbine; a lower collector to collect water rotating the hydraulic turbine; and a simple generating device installed in a discharge pipe of the lower collector and rotated by discharged water, thereby producing electricity, wherein the hydraulic turbine includes a top rotary shaft and a bottom rotary shaft installed on upper and lower portions, respectively, by a main frame and a circulating belt that is in a closed loop to be rotated while being wound around the top and bottom rotary shafts and includes a load transfer means formed on an outer surface thereof, which is rotated by water supplied from the upper water tank; wherein the simple generating device includes a propeller installed in the discharge pipe and rotated by a water discharge pressure, a simple rotary shaft coupled to the propeller and withdrawn to the outside of the discharge pipe; and a simple generator to generate electricity by the rotational force of the simple rotary shaft.

### TECHNICAL FIELD

The present invention relates to a pumped-storage hydroelectricity generator, more particularly, to a pumped-storage hydroelectricity generator with improved efficiency, capable of maximally converting water stored in an upper portion of the generator while minimizing loss thereof.

### BACKGROUND ART

In general, a pumped-storage hydroelectricity generation (“pumped water generation”) is employed in a region with lack of water source, wherein water in a lower region is pumped and transferred to the upper region at midnight having little power consumption while descending the water stored in the upper region to the lower region in order to produce power.

Pumped water generation converts potential energy of water into electric energy, and a pumped water generator typically consists of a rotational hydraulic turbine that is rotated by the potential energy of water and converts the potential energy into mechanical energy, a generator that converts the mechanical energy generated by the rotational hydraulic turbine into electric energy, and a transformer that switches the electric energy generated by the generator into useable voltage. In this regard, in order to change the potential energy of water into mechanical energy as much as possible, the rotational hydraulic turbine is critical and may be one of significant factors having effects on electricity production.

Korean Utility Model Registration No. 20-0424078 (registered on Aug. 9, 2006; hereinafter referred to as ‘cited invention 1’) discloses a hydroelectricity generating apparatus using a well bucket type hydraulic turbine. According to cited invention 1, an upper water tank and a drive chain wheel are mounted on an upper portion between left and right struts; a lower water tank and an idle rotation chain wheel are provided on a lower portion between the struts, wherein the upper and lower water tanks are connected through a transport pipe equipped with a motor pump driven by external electric power, in order to circulate water; the drive chain wheel and the idle chain wheel are connected by left and right drive chains; a plurality of water gourds is provided on a surface of the left and right drive chains at a constant interval; the uppermost gourd receives water dropping from a drop-hole of a water collection chamber in the upper water tank, wherein a speed reduction chain gear is interposed at initial driving to minimize overload, so as to change the rate of rotation required for generating electricity by a summed weight of the water contained in the plurality of water gourds; transmission chain gears installed at both ends of a transmission shaft are connected to one another transmission chain gear mounted on the transmission shaft by a chain belt; a fly-wheel is provided between the transmission shaft and the transmission chain gear mounted on the transmission shaft; the transmission chain gear mounted on the transmission shaft and an electromotive chain gear installed between the struts are connected by another chain belt; and another electromotive chain gear coaxially installed with the above electromotive chain gear is connected to a chain gear in the generator by an additional chain belt.

Korean Patent Registration No. 10-1062246 (registered on Aug. 30, 2011; hereinafter referred to as ‘cited invention 2’) proposes a turbine for hydroelectric power generation. According to cited invention 2, the turbine for hydroelectric power generation comprises: a pair of first chain wheels installed at a predetermined interval on a first rotary shaft provided with a gear at one end thereof; a pair of second chain wheels installed at a predetermined interval on a second rotary shaft; a pair of chains provided in a closed loop form on the first and second chain wheels, respectively; a belt fixed on an outer surface of the chains; and a plurality of gutters provided around the belt, wherein each gutter has flexibility and a flexible cable is mounted on the edge of an upper opening of the gutter.

Cited inventions 1 and 2 describe a configuration characterized in that: top and bottom rotary shafts are provided; a belt including a plurality of receptors to receive water is circularly mounted on each of the rotary shafts such that, when water is introduced into the receptors in the belt, the water may allow circulation of the belt in a single direction by a load of the water; and the circulating belt rotates the rotary shaft to produce electricity.

However, in order to convert the water stored in the upper water tank into electric energy, it is necessary to minimize a loss in amount of water when introduced from the upper water tank to the receptors in the belt. Actually, due to high rate of rotation of the belt, a large amount of water supplied to the receptors in the belt is lost. Until now, no practical or specific means to overcome the above problem has been disclosed, hence entailing a disadvantage of significant deterioration in electricity productivity.

Therefore, a novel structure that can convert potential energy of water into electric energy as much as possible, without water loss, will be needed.

### DISCLOSURE

### Technical Problem

The present invention has been designed to solve the problem of the conventional art described above, and an object of the present invention is:

to provide an apparatus for maximally converting potential energy of water stored in an upper water tank, wherein water leaking to the outside of a receptor during supply of the water in a reservoir to a receiving bucket is collected and re-introduced into another receiving bucket at a lower portion by positioning a collector to capture leaked water at a part where the water in the reservoir is supplied to the receptor in the belt.

Further, another object of the present invention is to provide an apparatus with an electricity generating structure, wherein a leaked water collector is fixed at a fixed frame using a spring and, when the leaked water hits an inner surface of the leaked water collector, a position of the leaked water collector is varied and a part of the leaked water collector hits a piezoelectric element mounted on the fixed frame to thus generate electricity.

### Technical Solution

In order to accomplish the above object, according to preferred embodiments of the present invention, there is provided a pumped-storage hydroelectricity generator (‘pumped water generator’), including:

an upper water tank to store pumped water, rainwater, or river water input via a pipe using midnight electricity; a hydraulic turbine that receives the stored water from an outlet of the upper water tank and is rotated to generate rotational force; a generator to produce electricity by the rotational force of the hydraulic turbine; a lower collector to collect water rotating the hydraulic turbine; and a simple generating device installed in a discharge pipe of the lower collector and rotated by discharged water, thereby producing electricity. Herein, the hydraulic turbine may include: a top rotary shaft and a bottom rotary shaft installed on upper and lower portions, respectively, by a main frame; and a circulating belt that is in a closed loop to be rotated while being wound around the top and bottom rotary shafts and includes a load transfer means provided on an outer surface thereof, which is rotated by water supplied from the upper water tank. Further, the simple generating device may include: a propeller installed in a pipeline and rotated by a water discharge pressure; a simple rotary shaft coupled to the propeller and withdrawn to the outside of the pipeline; a simple generator to generate electricity by rotational force of the simple rotary shaft; and a charger to charge the electricity generated in the simple generator.

Further, a sprocket may be installed on the rotary shaft of the hydraulic turbine and the circulating belt may be linked to a chain engaging with the sprocket, thereby enabling rotation of the belt.

In addition, the load transfer means may be configured such that a plurality of receiving buckets, each having an inner space to receive the supplied water, is arranged at a predetermined interval in a length direction.

Further, a leaked water collector configured of both side walls and a front wall to have a U-shaped horizontal end is fixed on the top of the hydraulic turbine by the fixed frame, so that the receiving bucket of the circulating belt may receive and store the water supplied from the upper water tank while passing downward through the inside of the leaked water collector, and a large amount of water leaking during storage may be guided to a lower curved surface of the leaked water collector bent toward the circulating belt and supplied again and stored in another receiving bucket on the lower portion.

In this case, the leaked water collector may include: a collecting body configured of both side walls and a front wall; collecting connection members horizontally protruded from both sides of the collecting body and connected to the fixed frame by springs; and a strike rod vertically mounted on both side walls of the collecting body, through which the fixed frame is inserted. The fixed frame may include: a fixed connection member protruded in a direction of the leaked water collector and connected and fixed to the collecting connection members by springs; a plurality of side piezoelectric elements installed along the outer surface and arranged apart from an inner surface of the strike rod at a predetermined interval; a shoulder protruded toward a portion spaced from the bottom end of the strike rod at a predetermined interval in order to restrict downward-movement of the strike rod; a bottom piezoelectric element installed on the top of the shoulder and struck by the strike rod moving downward by elasticity; and a charger to charge electricity generated by the side piezoelectric elements and the bottom piezoelectric element.

According to another embodiment, the hydraulic turbine may further include a vertical drop pipe that receives water supplied from the upper water tank and drops the water downward and has a vertical groove formed on one side, wherein the vertical groove of the vertical drop pipe is in close contact with the circulating belt, which in turn moves while closing the vertical groove. Herein, the circulating belt may include a plurality of horizontal partitions formed in a length direction as the load transfer means, wherein the horizontal partitions are inserted into the vertical drop pipe through the vertical groove to partition off an inner space while being rotated on an upper portion of the vertical drop pipe, and wherein the horizontal partitions escape from the vertical groove to discharge the stored water while being rotated on a lower portion of the vertical drop pipe.

### Advantageous Effects

As described above, the pumped water generator of the present invention may have configurations wherein:

water at a high position is supplied to the circulating belt to convert potential energy into rotational energy and produce electricity; and water leakage is minimized during supply of water into the circulating belt or the leaked water may be recycled to the circulating belt, thereby accomplishing a useful device with improved electricity production efficiency.

### DESCRIPTION OF DRAWINGS

FIGS. 1a and 1b are configuration views illustrating a pumped water generator and a simple generating device, respectively, according to one embodiment of the present invention.

FIG. 2 is a partial perspective view illustrating major parts of a hydraulic turbine according to one embodiment of the present invention.

FIGS. 3a and 3b are a plan view and a side cross-sectional view illustrating arrangement of a leaked water collector, respectively, according to one embodiment of the present invention.

FIGS. 4a and 4b illustrate combined states of a leaked water collector provided with different piezoelectric elements according to one embodiment of the present invention.

FIGS. 5a and 5b are schematic views illustrating another form of the hydraulic turbine according to the present invention.

### BEST MODE

Hereinafter, the present invention will be described in detail by means of preferred embodiments. However, the present invention may also be embodied in different forms and should not be limited to the embodiments set forth herein. Rather, the present embodiments are proposed to definitely complete the contents described herein and fully communicate the spirit and scope of the present invention to those skilled in the art.

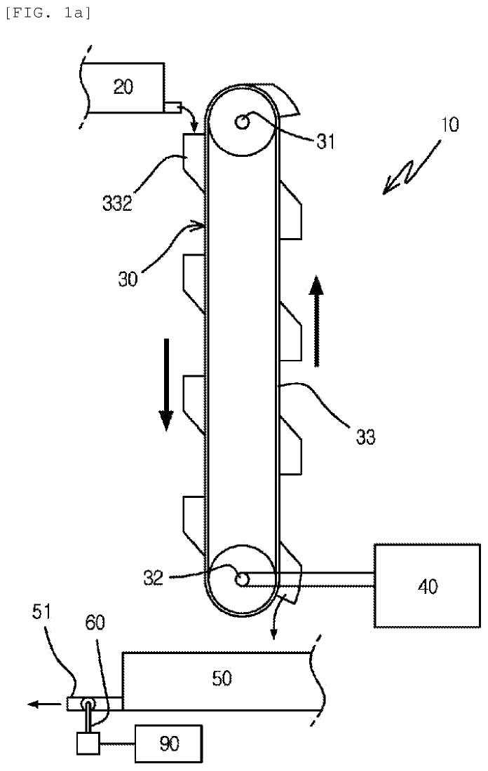

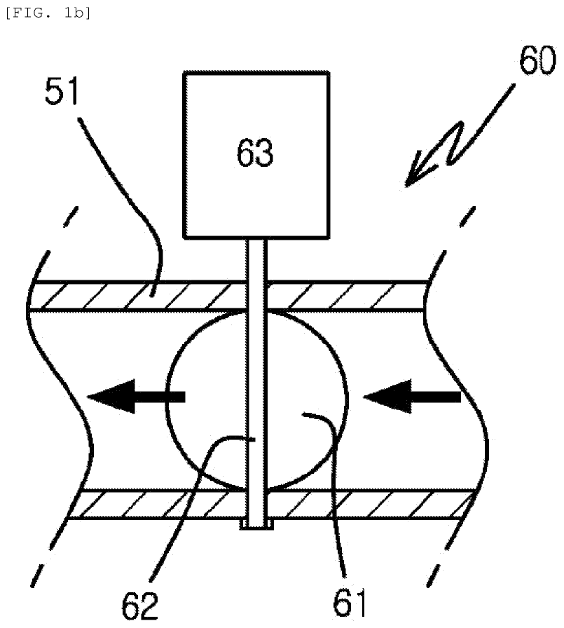

FIG. 1a is a configuration view illustrating a pumped water generator according to the present invention.

As illustrated, the pumped water generator 10 of the present invention may include an upper water tank 20, a hydraulic turbine 30, a generator 40, a lower collector 50, and a simple generating device 60.

The upper water tank 20 may pump water from a lower part or store rainwater using midnight electricity with small electric consumption, and may partially guide river water to an area having a high difference in elevation (‘head’), thereby preparing fresh water by combining any of these methods described above. The upper water tank 20 has an outlet at one side to discharge stored water in one direction wherein an intermittent valve is mounted at the outlet to discontinuously discharge the water. The simple generating device may include a propeller, a simple rotary shaft and a simple generator and be installed on a discharge line, so as to convert a discharge pressure into electric energy and transmit the same to a power supply line or store the electric energy in a separate charger.

The hydraulic turbine 30 may include a top rotary shaft 31 and a bottom rotary shaft 32, respectively, mounted on the upper and lower portions by the main frame, as well as a circulating belt 33. The top rotary shaft 31 and the bottom rotary shaft 32 may have a plurality of rolls arranged with predetermined diameters, a single large-diameter roll, or a plurality of large-diameter rolls having a small width coaxially arranged about an axis so as to ensure circulation, thereby accomplishing rotation of the circulating belt and switching a traveling direction.

Sprockets 311 are installed at both ends of each of the top rotary shaft 31 and the bottom rotary shaft 32, while chains 331 corresponding to the sprockets are coupled to the circulating belt 33 and receive power from the same, thereby securing rotation of the belt.

Further, the circulating belt 33 may receive a load of the water supplied from the upper water tank and descend one side of the belt, thereby rotating the top and bottom rotary shafts. The circulating belt may be provided with the load transfer means to receive the water load.

For instance, the load transfer means may be configured such that a plurality of receiving buckets 332, each having a receiving space therein, is arranged at a predetermined interval in a length direction of the circulating belt 33. In this case, an open portion of each receiving bucket 332 faces upward at a position in the upper water tank 20 to receive the supplied water in order to easily fill with the supplied water. Further, due to the weight of the contained water, the bucket may descend and the circulating belt 33 may be rotated in a single direction.

Further, the receiving bucket 332 is made of an elastic material and is rotated by the top or bottom rotary shaft, thereby facilitating a change in shape when the traveling direction is altered. Further, an open inlet portion only may be made of a metallic material, thereby easily securing the inlet opened when feeding water.

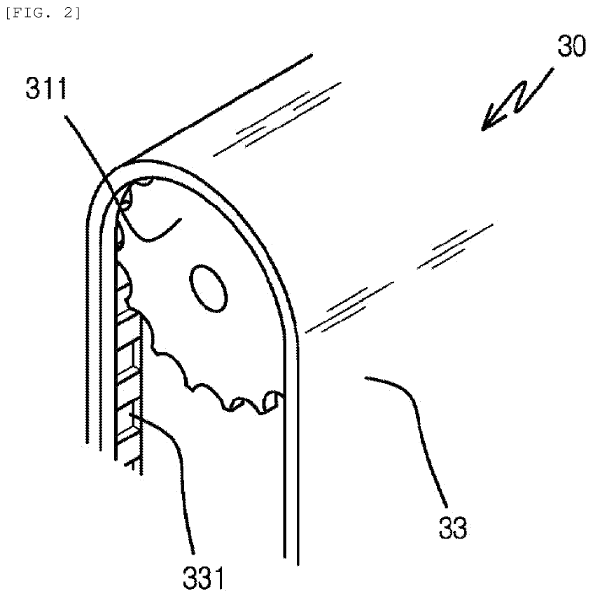

Further, the chain 331 coupled to the circulating belt 33 may be integrally formed on an inner surface of the circulating belt 33, as described with reference to FIG. 2, whereby the top rotary shaft and the bottom rotary shaft may be rotated together while descending the circulating belt.

Next, the top rotary shaft 31 or the bottom rotary shaft 32 may be connected to the generator 40 to produce electricity by rotation. The generator 40 preferably generates electricity by conversion to desired rate of rotation through a transmission or a speed reducer rather than being directly connected to the top rotary shaft or the bottom rotary shaft. Further, the electricity produced by the generator may be supplied to a power system after regulating voltage through a transformer, or may be stored in the charger and used if needed. As such, power supply may be achieved according to various well-known methods.

The lower collector 50 may temporarily collect the water that has rotated the circulating belt and then discharge the same. That is, the water stored in the upper water tank 20 descends through the hydraulic turbine 30 and moves the circulating belt 33, and the moved circulating belt rotates the top rotary shaft 31 or the bottom rotary shaft 32, and then, uses potential energy to produce electric energy in such a manner as to produce electricity in the generator 40 by the rotational force. Herein, the water having moved the circulating belt is discharged from the receiving bucket 332, collected in the lower collector 50, and then, exhausted to the outside through the discharge pipe 51.

The simple generating device 60 is disposed on the discharge pipe 51 of the lower collector and undergoes rotation by the discharged water, thereby producing electricity.

The simple generating device 60 may include: a propeller 61 installed in the pipeline and rotated by a pressure of the discharged water; a simple rotary shaft 62 coupled to the propeller and withdrawn to the outside of the pipeline; and a simple generator 63 to generate electricity by rotational force of the simple rotary shaft.

FIG. 1b is a plan view illustrating the discharge pipe of the lower collector, which is cut in a horizontal direction. Referring to this figure, the propeller 61 rotated by the discharged water is provided in the discharge pipe 51. The propeller may have the same size as a vertical cross-section of the discharge pipe and be rotated about a rotational axis formed in the center thereof. Otherwise, a portion having the propeller mounted thereon may be extended and the propeller may be disposed on the lower portion only in a main discharge passage of the pipe, thereby receiving the delivered discharge pressure and being rotated.

Further, the simple rotary shaft 62 is connected in the center of the propeller and withdrawn to the outside of the pipe in order to transfer rotational force of the propeller to the outside of the discharge pipe. As such, one or a plurality of propellers may be installed in the discharge pipe of the lower collector and each propeller may be provided with the simple rotary shaft, whereby the discharged pressure may be converted into the rotational force.

The simple rotary shaft 62 may be connected to the simple generator 63 to induce generation and, when the simple rotary shaft is configured in plural, the simple generator may be mounted on each of the simple rotary shafts to produce electricity. Otherwise, a single rotary shaft may be converged by a separate belt pulley or a sprocket, and electricity may be produced through a single simple generator 63. Further, the simple rotary shaft may be directly connected to the simple generator to transfer the rotational force, or may convert the rotational force into desired rate of rotation using a transmission, followed by establishing production of electricity.

Further, the electricity produced in the simple generating device 60 may be supplied to a power supply line via a transformer, or may be charged in a separate charger 90 and then used in an emergency or as a power in reserve to drive the pumped water generator.

With regard to the configuration as describe above, in order to maximally use the water stored in the upper water tank for power generation, the hydraulic turbine may be further provided with a leaked water collector 70.

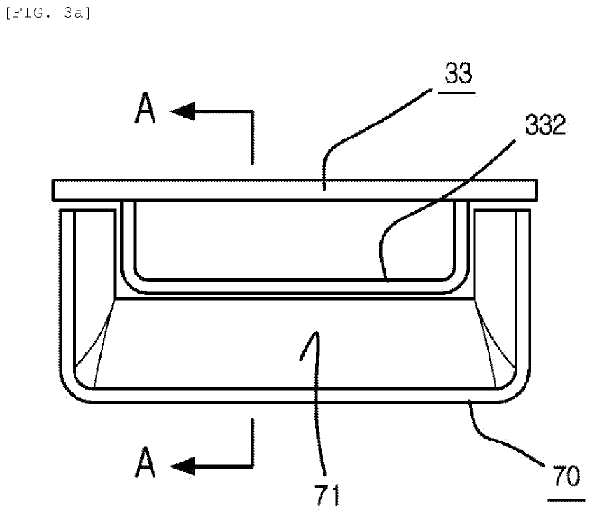

Referring to FIGS. 3a and 3b, the leaked water collector 70 surrounding the receiving bucket 332 is further installed on an upper portion of the hydraulic turbine, wherein water is fed from the upper water tank 20 to the receiving bucket 332 of the circulating belt 33, whereby water leaking while being charged may be recycled to another receiving bucket positioned on a lower side, thereby being converted into rotational energy.

The leaked water collector 70 is fixed on top of the hydraulic turbine, has both side walls and a front wall integrally combined to form a U-shaped horizontal end, and is securely fixed by the fixed frame 80. In this case, the fixed frame 80 may be fixed to one side of a main frame that supports the top rotary shaft 31 or the bottom rotary shaft 32 or, independently of the main frame, may be separately installed and the leaked water collector may be disposed near the discharge pipe of the upper water tank.

The leaked water collector 70 as described above may be configured such that a rear side of the horizontal end is closely arranged at a front surface of the circulating belt 33, that is, near a surface on which the receiving bucket 332 is provided. As a result, lateral sides are all closed, and water is supplied while the receiving bucket passes through the collector and thus is contained in the receiving bucket.

The leaked water collector 70 is formed to have a curved surface on a lower portion of an inner wall thereof so as to face a flow passage, through which the receiving bucket of the circulating belt moves. Therefore, when water leaks, the leaked water may be guided to the curved surface inside the leaked water collector 70 and then supplied and stored in another receiving bucket positioned on the bottom of the previous receiving bucket. Accordingly, the receiving bucket 332 is not filled to a full water level when supplied with water from the upper water tank 20 but with 60 to 80% of an inner space thereof to remain a spare space, followed by additionally storing the leaked water guided from the leaked water collector 70 so as to allow descent of the water.

The leaked water collector 70 may have a collecting body 71 configured of both side walls and a front wall to have a U-shaped horizontal end. The collecting body 71 may have an inner surface gently curved on a lower portion thereof, which is configured to collect the leaked water generated while putting the water in the receiving bucket to thus guide the same therein along the inner curved surface, so as to receive the water in the receiving bucket on a lower side.

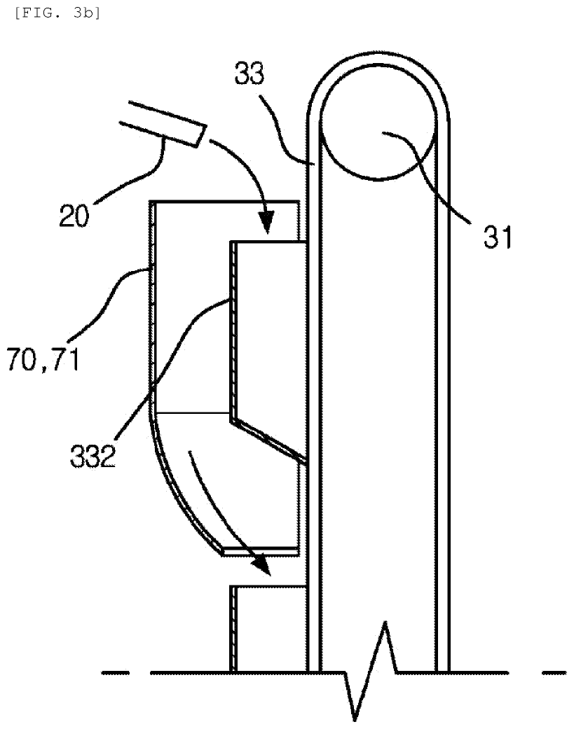

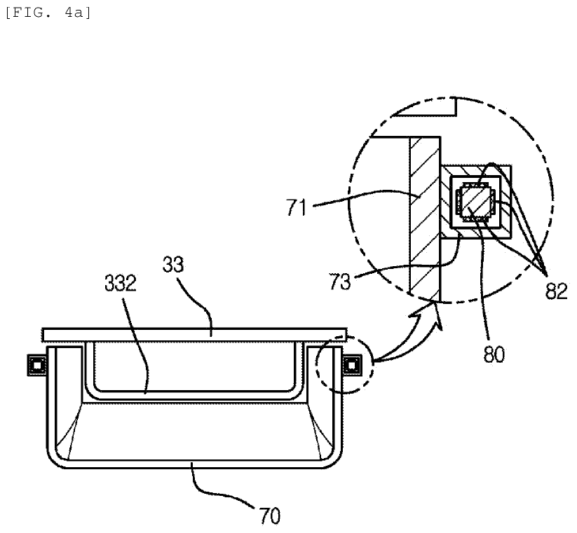

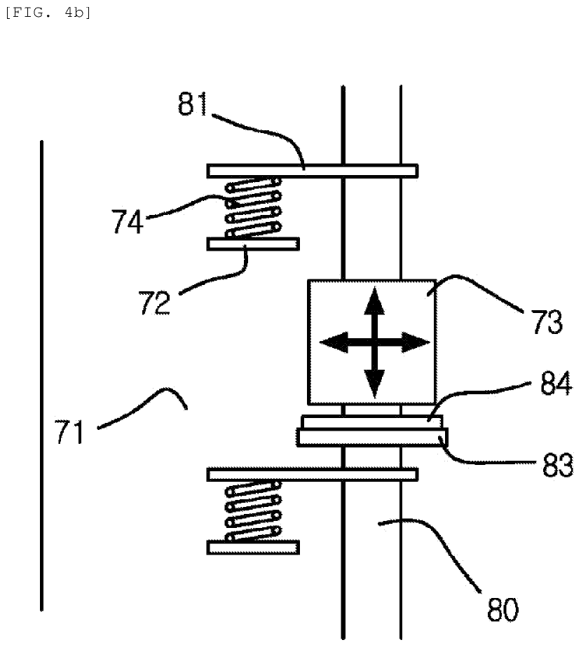

Referring to FIGS. 4a and 4b, the pumped water generator according to the present invention may further include a piezoelectric element such that load applied to the leaked water collector is switched into electricity by the piezoelectric element.

The leaked water collector 70 may be further provided with a collecting connection member 72 horizontally protruded at both sides of the collecting body, and a strike rod 73 in a vertically hollow bar form. The collecting connection member 72 may be formed in plural on upper and lower portions at both sides of the collecting body 71, and coupled together by the fixed frame 80 and springs 74. As such, since the collecting connection members are connected by the springs 74 in four points at both sides, water leaking when filling the receiving bucket 332 with water may hit or impact the collecting body 71 of the leaked water collector and the leaked water collector may move back and forth and up and down. Herein, if a piezoelectric element is installed at a position to which the leaked water collector moves, vibration occurring in the leaked water collector due to the leaked water may also be switched into electricity.

Moreover, the fixed frame 80 to secure the leaked water collector 70 is installed by inserting a strike rod 73 of the leaked water collector through the same. Further, side piezoelectric elements 82 may be vertically installed in back and forth, and left and right sides on a portion close to an inner surface of the strike rod, whereby the strike rod 73 may hit the side piezoelectric elements 82 during positional movement along the x-axis and y-axis to produce electricity.

Further, the fixed frame 80 may have a shoulder 83 protruded on a lower portion apart from the position of the strike rod 73 at a predetermined interval, while a bottom piezoelectric element 84 is horizontally installed on a top surface of the shoulder so that, when the leaked water collector moves up and down, the bottom end of the leaked water collector hits the bottom piezoelectric element 84 so as to produce electricity.

The leaked water collector 70 is connected to the fixed frame 80 by the spring 74. That is, the collecting connection member 72 is provided on upper and lower portions at both sides of the leaked water collector, and a fixed connection member 81 is integrally formed on the fixed frame in order to correspond to the collecting connection member, whereby the collecting connection member 72 and the fixed connection member 81 are connected by the spring 74 so that a position of the leaked water collector 70 may be varied even by weak impact and the leaked water collector may hit the side piezoelectric elements 82 or the bottom piezoelectric element 84, thereby producing electricity. Further, in addition to vibration caused by the leaked water, wind may also move the leaked water collector 70 to impact the side piezoelectric elements or bottom piezoelectric element 82, 84. Therefore, wind energy may also be used to produce a small amount of electricity.

Further, since the leaked water collector 70 is suspended on the fixed frame 80, it is preferable to configure the leaked water collector such that the fixed connection member 81 is disposed on an upper portion while positioning the collecting connection member 72 on a lower portion, followed by connecting these members using the spring 74. Further, each of the strike rod 73 and the fixed frame 80 may be configured to have a circular cross-section or, as shown in the figures, may be formed in a square bar shape, thereby facilitating installation of the side piezoelectric elements and easily hitting the same.

Further, the electricity produced by the side piezoelectric elements 82 and the bottom piezoelectric element 84 is directly transmitted to a power supply line and may be used. However, due to a small amount of the electricity, charging may also be required using the charger 90 and the electricity may be used after completion of charging. Alternatively, the above electricity may be used as emergency power or power for driving facilities.

According to the present invention, the pumped water generator 10 configured as described above may store water induced from nearby rivers, rainwater or pumped water in the upper water tank and may discharge the water along the length, while the discharged water descends through the hydraulic turbine to convert potential energy of the water into rotational energy.

In addition, in a course of collecting the water discharged after producing electricity in the lower collector and then discharging the same, simple generation may occur to thus produce additional electricity.

Moreover, the leaked water collector 70 is further provided to collect the water leaking when supplied from the upper water tank 20 to the hydraulic turbine, in particular, a receiving bucket 332, and then, to again supply the collected water to another receiving bucket on a lower side, thereby achieving conversion into electric energy.

Furthermore, the leaked water collector 70 is installed such that the collector can move to back and forth, left and right, and up and down when struck by the spring 74. Therefore, during collection of the leaked water or when vibration occurs by the wind, for example, the generated vibration may impact the piezoelectric element to further produce electricity. As such, it is possible to produce electric energy as much as possible while minimizing loss of potential energy of the water stored in the upper water tank.

In addition, if a height of the pumped water generator is increased or a plurality of pumped water generators is arranged up and down in order to pass and descend the water stored in the upper water tank to the plurality of pumped water generators, specifically, hydraulic turbines in sequence, maximum production of electricity may be possible even using limited water resources.

1. A pumped-storage hydroelectricity generator (‘pumped water generator’), comprising:
an upper water tank (20) to store pumped water, rainwater, or river water input via a pipe using midnight electricity;
a hydraulic turbine (30) that receives the stored water from an outlet of the upper water tank and is rotated to generate rotational force;
a generator (40) to produce electricity by the rotational force of the hydraulic turbine;
a lower collector (50) to collect water rotating the hydraulic turbine; and
a simple generating device (60) installed in a discharge pipe (51) of the lower collector and rotated by discharged water, thereby producing electricity,
wherein the hydraulic turbine (30) includes: a top rotary shaft (31) and a bottom rotary shaft (32) installed on upper and lower portions, respectively, by a main frame; and a circulating belt (33) that is in a closed loop to be rotated while being wound around the top and bottom rotary shafts and comprises a load transfer means formed on an outer surface thereof, which is rotated by water supplied from the upper water tank,
wherein the simple generating device (60) includes: a propeller (61) installed in the discharge pipe and rotated by a water discharge pressure; a simple rotary shaft (62) coupled to the propeller and withdrawn to the outside of the discharge pipe; and a simple generator (63) to generate electricity by the rotational force of the simple rotary shaft;
wherein the load transfer means includes receiving buckets (332), each having an inner space to receive the supplied water, arranged at a predetermined interval in a length direction, and
wherein a leaked water collector (70) configured of both side walls and a front wall to have a U-shaped horizontal end is fixed on the top of the hydraulic turbine (30) by a fixed frame, so that the receiving bucket (332) of the circulating belt receives and stores the water supplied from the upper water tank while passing downward through the inside of the leaked water collector, and a large amount of water leaking during storage is guided to a lower curved surface of the leaked water collector bent toward the circulating belt and supplied again and stored in another receiving bucket on a lower side.

2. The pumped water generator according to claim 1, wherein the leaked water collector (70) includes:
a collecting body (71) configured of both side walls and the front wall;
collecting connection members (72) horizontally protruded from both sides of the collecting body and connected to the fixed frame (80) by springs (74); and
a strike rod (73) vertically mounted on both side walls of the collecting body, through which the fixed frame is inserted, and
wherein the fixed frame (80) includes:
a fixed connection member (81) protruded in a direction of the leaked water collector, and connected and fixed to the collecting connection member by a spring;
a plurality of side piezoelectric elements (82) installed along the outer surface and arranged apart from an inner surface of the strike rod at a predetermined interval;
a shoulder (83) protruded toward a portion spaced from the bottom end of the strike rod at a predetermined interval in order to restrict downward-movement of the strike rod; and
a bottom piezoelectric element (84) installed on the top of the shoulder and hit by the strike rod moving downward by elasticity.
